(19) United States
(12) Patent Application Publication
(10) Pub. No.: US 2017/0362484 A1
(43) Pub. Date: Dec. 21, 2017

(54) PROCESSES AND MEDIA FOR HIGH TEMPERATURE HEAT TRANSFER, TRANSPORT AND/OR STORAGE

(71) Applicant: Gas Technology Institute, Des Plaines, IL (US)

(72) Inventors: Hamid ABBASI, Naperville, IL (US); David CYGAN, Villa Park, IL (US); David M. RUE, Chicago, IL (US); William E. LISS, Libertyville, IL (US)

(73) Assignee: Gas Technology Institute, Des Plaines, IL (US)

(21) Appl. No.: 15/187,993

(22) Filed: Jun. 21, 2016

(51) Int. Cl. C09K 5/14; F28D 15/00; F28D 20/00; F28F 23/00

(52) U.S. Cl. CPC C09K 5/14; F28F 23/00; F28D 15/00; F28D 20/0056; F28F 2250/08

(57) ABSTRACT

A thermal energy conveyance process involving at least one of transferring heat to a first heat transfer fluid and recovering heat from a second heat transfer fluid, wherein the first and the second heat transfer fluids include a gaseous carrier containing a quantity of micron sized solid particles and wherein the at least one of transferring heat and recovering heat is conducted to involve at least one of a) a temperature in excess of 1000° F. and b) a dilute-to-dense phase of the micron sized solid particles. Also provided is a media adapted for such heat conveyance operation.

### STATEMENT REGARDING FEDERALLY SPONSORED RESEARCH OR DEVELOPMENT

This invention was made with government support under grant DE AR0000464 awarded by the Department of Energy. The government has certain rights in the invention.

### BACKGROUND OF THE INVENTION

### Field of the Invention

This invention relates generally to thermal energy conveyance and, more particularly, to the transfer, transport and/or storage of heat such as can find application in a wide variety of industrial, commercial, institutional, power generation, residential and/or other applications.

### Discussion of Related Art

The U.S. industrial sector annually consumes nearly one-third of the total U.S. energy use of nearly 100 quads, of which a large portion is used in energy intensive processes that operate above 800° F./1427° C. (hereinafter the application text presents temperatures mostly in units of ° F. while the examples and figures commonly employ units of ° C.). Examples of such industrial sector processes include high pressure steam generation, heat treating, metal and non-metal heating and melting, curing and forming and calcining.

A wide range of technologies and materials are available or under development for heat transfer and elevated temperature thermal energy storage and regeneration. However, technologies and materials that effectively operate at temperatures approaching 1100° F. or higher, such as typically required to deliver high exergy efficiencies, remain a challenge. Generally, higher temperatures mean fewer options, higher costs, and reduced reliability.

A number of specific approaches have been investigated for thermal energy storage. One approach is to hold heat, such as from generated steam, in a bed of sand or refractory material by incorporating embedded steam pipes and to recover the heat later from the hot bed to generate power. A second approach is to transfer the heat to an organic liquid that is then held in a ‘hot’ tank until needed to generate steam such as for a turbine. After transferring heat, the organic liquid is pumped to a ‘cold’ tank in preparation for collecting more heat. Organic liquids in such applications are generally limited to operating temperatures well below 750° F., and suffer from problems with volatilization and degradation reactions.

The concept of mixing solid particles in a gas to increase radiation and conductive/convective heat transfer has been previously explored. For example, in the 1960's Farber and Depew investigated the effect on heat transfer at a solid wall of adding uniformly sized 30 to 200 micron spherical glass particles to a gaseous stream flowing in a tube. Their results indicate a substantial increase in heat transfer coefficient for 30 microns, a moderate increase for 70 microns, a slight increase for 140 microns and essentially no increase for the 200 micron particles. In the late 1970's and early 1980's, Hunt A. J. and colleagues investigated a new high temperature gas receiver using a mixture of ultra-fine carbon particles in a gas stream and exposing the suspension to concentrated sunlight to produce a high temperature fluid for power generation applications (Brayton Cycle). Their analysis showed receiver efficiencies close to 95% would be expected.

There has also been considerable ongoing research on liquids mixed with solid nano particles to create improved heat transfer fluids (primarily for low temperature heat sink applications) and on increasing radiation heat transfer from flames by low level particle seeding.

Except for the receiver, most of the other work on two-phase fluids containing gas and solid particles has been limited to relatively low temperatures and/or low levels of loading.

Current state-of-the-art thermal storage is commonly carried out using mixtures of nitrate salt. In currently deployed systems, molten salts are circulated to collect heat and the heated salts are stored in a ‘hot’ tank. When additional power production is desired, the hot molten salt is used to generate high pressure steam for the turbine. The molten salt is then stored at a lower (but not ambient) temperature in a ‘cold’ tank. Such a process creates a closed system so no salt make-up is required. The most commonly used salts are saltpeter or mixtures of sodium and potassium nitrates operating at temperatures as high as 1020° F. One of the advantages of molten salt thermal energy storage is that the molten salt does two jobs. Molten salt is pumped through the heat source and collects heat. Then the hot molten salt serves as a heat sink to generate steam at a later time. Molten salts avoid the volatility problems of liquid organic energy storage fluids, and molten salts can work at higher maximum temperatures. This elegance comes with limitations imposed by the properties of the molten salts. The limitations include:

a. The salts must be kept molten. Such nitrate mixtures melt at temperatures >435° F., meaning that all lines and even the ‘cold’ tank must be insulated and kept at a high enough temperature to prevent freezing or solid deposition in the pipes.

b. Viscosities must be kept low. Over the temperature range of 480 to 930° F., molten salt mixture viscosities can vary by a factor of 5. This increases pump duty, the cost of pumps, and the electricity needed to pump the molten salts.

c. Side reactions must be avoided. Nitrate salts can react with carbon dioxide and oxygen in the air to produce carbonate and nitride salts that change the molten salt mixture properties. Even more damaging is the formation of nitric acid by reaction with air at high temperatures.

d. Some molten salt mixtures are expensive. Improving molten salt properties by lowering the melting point, lowering viscosity, increasing working temperature range, and raising temperature can be accomplished by adding other salts such as lithium and calcium nitrate to the mixture. These other salts, especially lithium nitrate, are costly and add significant capital cost to the thermal energy storage system.

e. Molten salts are typically corrosive. Materials for tanks and lines must be carefully selected to limit corrosion. Increasing temperature from 480 to 930° F. can increase corrosion rates by a factor of 4. Compensating for the effects of corrosion adds capital cost.

f. The maximum working temperature is in the range of 750 to 1020° F. Above this temperature, they suffer from excessive corrosion rates and high levels of side reactions.

g. Researchers are pursuing the use of single tank nitrate salt storage using tanks with controlled temperature gradients. This approach eliminates one large tank but leads to some increase in size for the single tank and increased complexity and more controls.

A second major area of energy storage research that has experienced a great deal of study is the application and use of Phase Change Materials (PCMs). PCMs offer the potential to avoid problems related to corrosion and side reactions of molten salt mixtures. Another possible PCM advantage is that the majority of heat is stored and released at a constant temperature which can simplify steam production and stabilize turbine operation. Phase changes from solid to liquid, solid to gas, and liquid to gas are possible. But if one phase is a gas, large storage volumes are required, so investigators have tended to favor exploiting the smaller heat of fusion.

Three broad classes of potential PCMs have been investigated: organic compounds (paraffins, fatty acids, and others), metals (or eutectic metals), and salt hydrates.

Paraffins are generally good energy storage PCM candidates because they are typically relatively inexpensive, stable, can be chosen to melt at desired temperatures, have good nucleating properties, undergo congruent melting, have low liquid phase volatility, and have high heats of fusion. Paraffins, however, are not generally usable at high temperatures (e.g., temperatures of 1100° F. or greater), and they are poor thermal conductors. Fatty acids and other organic compounds have also been studied extensively. Fatty acids have high heats of fusion and good phase change behavior, making them attractive for lower temperature energy storage applications.

Metals and eutectic metals have generally been less explored as PCMs compared to organic compounds and salt hydrates. Metals face serious engineering challenges because of their weight. Metals have low heats of fusion by weight but high heats of fusion by volume. Metals have high thermal conductivities and low vapor pressures in the liquid state. Severe penalties for metals are their high weights and high costs compared with organic compounds (especially paraffins) and salts. As a result, metals and eutectic metals are generally not seriously considered currently as PCMs.

A third major area of energy storage research being actively pursued is thermochemical storage. The range of possible applications for the purpose of heat storage using thermochemical reactions is very wide, however these systems are expected to be more complex and also dependent on reaction rates. Starting from temperatures of around 160° F. (salt-hydrates and solutions) to typical dissociation processes of hydroxides at around 390-660° F., ammonia dissociation at 750-1290° F., up to around 2000° F. for solar thermal processes in tower plants. There are different possible mechanisms to store enthalpy, including:

a. Heat of dilution: Adding or removing water to a salt solution;

b. Heat of hydration: Absorbing or removing water molecules in a salt crystal;

c. Heat of solution: Solving and crystallizing a salt; and

d. Heat of reaction (including heat of hydrogenation): fusion and separation of two or more chemical substances.

### SUMMARY OF THE INVENTION

A general object of the subject development is to provide improved processes and media for heat transfer, transport and storage, particularly for heat transfer, transport and storage at high temperatures.

A more specific objective of the subject development is to overcome one or more of the problems described above.

In accordance with one embodiment, there is provided a thermal energy conveyance process involving at least one of:

a. transferring heat to a first heat transfer fluid; and

b. recovering heat from a second heat transfer fluid;

wherein the first and the second heat transfer fluids include a gaseous carrier containing a quantity of micron sized (10s to 100s micron diameter) solid particles and wherein the at least one of transferring heat and recovering heat is conducted to involve at least one of a) a temperature in excess of 1000° F. and b) a dilute-to-dense phase of the micron sized solid particles.

In another embodiment, there is provided a thermal energy conveyance process involving at least one of:

a. transferring heat to a first heat transfer fluid; and

b. recovering heat from a second heat transfer fluid;

wherein the first and the second heat transfer fluids include a gaseous carrier containing air and a quantity of micron sized solid particles, such as carbon or alumina and wherein the at least one of transferring heat and recovering heat is conducted to involve at least one of a) a temperature in excess of 1050° F. and b) a dilute-to-dense phase of the micron sized solid particles having a solids loading ratio of at least 2.

In another embodiment, a media adapted for at least one heat conveyance operation selected from the group consisting of heat transport, heat transfer and heat storage is provided. The media desirably includes or is composed of a gaseous carrier fluid containing a quantity of micron sized solid particles and wherein the at least one heat conveyance operation is conducted to involve at least one of a) a temperature in excess of 1000° F. and b) a dilute-to-dense phase of the micron sized solid particles.

As used herein, references to “high temperature” such as in reference to thermal energy conveyances such as may involve one or more of heat transfer, transport and/or storage are to be generally understood as referring to such processing at temperatures in excess of 1000° F., in excess of 1050° F., or in excess of 1100° F.

As used herein, references to “dilute-to-dense phase” such as in reference to the micron sized solid particles loading in the carrier gas employed in a subject thermal energy conveyance such as may involve one or more of heat transfer, transport and/or storage are to be generally understood as referring to such micron sized solids particle loading level of at least 2.0, micron sized solids particle loading level of at least 2.5, micron sized solids particle loading level of greater than 10, micron sized solids particle loading level of greater than 20, micron sized solids particle loading level of at least 30 or micron sized solids particle loading level of at least 100.

Further, references to “micron sized” solid particles are to be generally understood as corresponding to mean equivalent particle diameter.

Other objects and advantages will be apparent to those skilled in the art from the following detailed description taken in conjunction with the appended claims and drawings.

### BRIEF DESCRIPTION OF THE DRAWINGS

FIG. 1 is a simplified flow diagram illustrating one embodiment of the subject development in the context of a thermal energy conveyance process in a heat storage cycle application.

FIG. 2 is a simplified flow diagram illustrating one embodiment of the subject development in the context of a thermal energy conveyance process in a heat recovery cycle application.

FIG. 3 is a graphical presentation of baseline heat transfer increase versus solids loading ratio showing the effect of particle loading on heat transfer realized in the subject examples.

FIG. 4 is a graphical presentation of heat transfer increase enhancement factor versus particle loading showing heat transfer enhancement with particle loading ratio.

### DETAILED DESCRIPTION OF THE INVENTION

As described in greater detail below, there is provided a thermal energy conveyance process, such as involving at least one of transferring heat to a first heat transfer fluid and/or recovering heat from a second heat transfer fluid, wherein the first and the second heat transfer fluids include a gaseous carrier containing a quantity of micron sized solid particles and wherein at least one of transferring heat and recovering heat is conducted to involve operation at a high temperature, a dilute-to-dense phase loading of the micron sized solid particles. More particularly, such high temperature operation may involve a temperature in excess of 1000° F., in excess of 1050° F., or in excess of 1100° F. Operation with such or under such dilute-to-dense phase loading may involve micron sized solids particle loading level of at least 2.0, micron sized solids particle loading level of at least 2.5, micron sized solids particle loading level of greater than 10, micron sized solids particle loading level of greater than 20, or micron sized solids particle loading level of at least 30.

Those skilled in the art and guided by the teachings herein provided will understand and appreciate that heat transfer fluids as herein provided for process heating and other thermal transfer applications can potentially operate at temperatures of up to 2100° F. or even higher, without an associated pressure increase, while providing wide ranging flexibility in energy absorption, heat capacity and thermal conductivity for direct thermal transfer applications up to 2100° F. or even higher.

In accordance with one aspect of the invention, suitable heat transfer fluids involve mixing fine (10's to 100's of micron mean diameter) particles (e.g., carbon, sand, minerals, refractory, metals, composite, glass, multi-component, or layered) with suitable one or more characteristics of service temperature, melting point, thermal conductivity and absorptivity (useful if directly exposed to radiation in a transmissive flow conduit) in an inert gas (e.g., N₂, CO₂ etc.) to create the heat transfer fluid. Compared with gas only heat transfer fluids, particle laden heat transfer fluids as herein provided enable or allow one or more of: a) an increase in the radiation absorption (if directly exposed to the radiation); b) operation up to the working temperature of the solid particles; and c) a simultaneous increase in the thermal conductivity and heat transfer coefficient of the carrying gas. With proper selection of the gas and particles, the heat transfer fluid can be used to transfer and store thermal energy at up to 2100° F. or higher depending on the process needs and heat source availability. The hot fluid may go through a supplementary fired heater if needed, to increase its temperature to the desired levels, for example in solar applications when the solar radiation levels are insufficient to generate the required process temperatures. The hot fluid then flows to a heat exchanger, transfers heat to the work load (e.g., food processing, mineral processing, water heating, steam generation, air heating, organic fluid heating or boiling) and the cooler fluid returns for reheating.

Use and processing of heat transfer fluids such as herein described will be further described herein below making specific mention to solar energy related thermal energy conveyance process, those skilled in the art and guided by the teachings herein provided will understand and appreciate that these heat transfer fluids can be used in a wide variety of applications including those involving transport and storage of energy from radiative, conductive and/or convective heat sources, including in heat recovery applications.

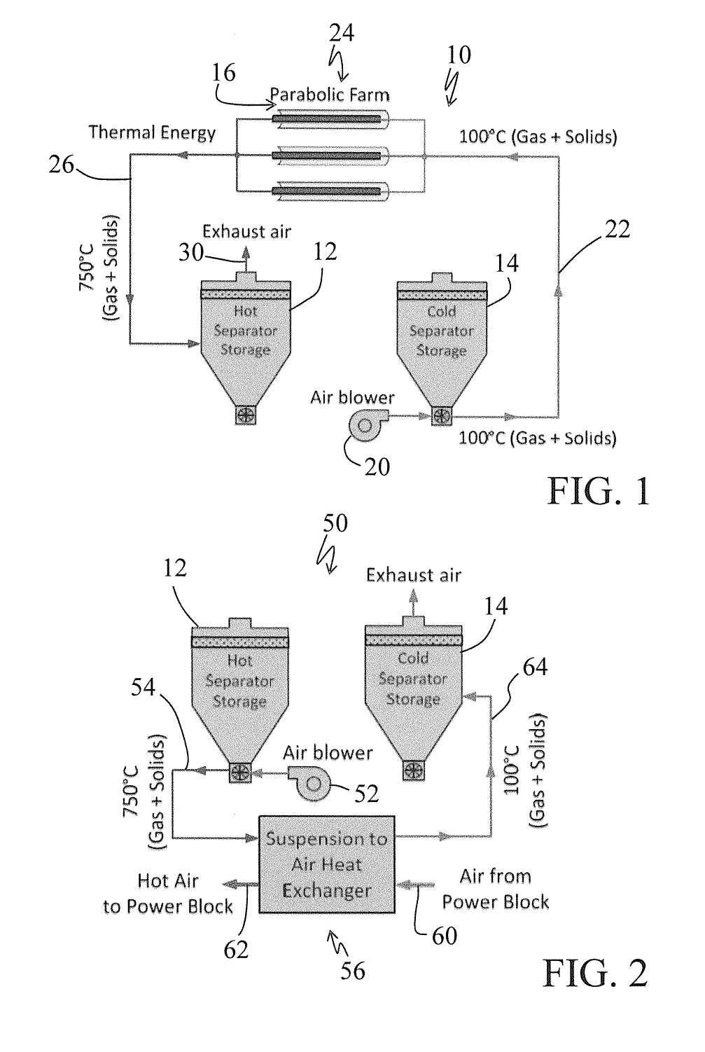

FIG. 1 is a simplified flow diagram illustrating one embodiment of the subject development in the context of a thermal energy conveyance process, generally designated by the numeral 10, in a heat storage cycle application. More specifically, the thermal energy conveyance process 10 integrates hot and cold storage, 12 and 14, respectively, as applied to or used in conjunction with a concentrated solar power farm 16 using parabolic reflectors. The concept will also be applicable to other solar collector designs including Fresnel, Dish and Power Tower types, for example.

During the heat storage cycle, solid particles from the cold separation and storage vessel(s) 14 are mixed with a carrier fluid, such as air such as supplied or provided via an air blower or compressor 20, and transported via a line 22 to and through a heating zone, generally designated 24, such as a through concentrated solar energy absorbers in the solar farm 16. The fluid-particle mixture is heated in the absorbers to an elevated temperature and the heated mixture is then transported via a line 26 to the hot separation and storage vessels(s) 12, where the particles are separated from the carrier fluid (such as with the separated carrier fluid forming an exhaust air stream 30).

FIG. 2 is a simplified flow diagram illustrating one embodiment of the subject development in the context of a thermal energy conveyance process, generally designated by the reference numeral 50, in a heat recovery cycle application and such as may be used in conjunction or in association with the heat storage cycle thermal energy conveyance process 10 shown in FIG. 1 and described above. While the heat recovery cycle thermal energy conveyance process 50 is described further below making reference to such a process used in conjunction or in association with the heat storage cycle thermal energy conveyance process 10 shown in FIG. 1, those skilled in the art and guided by the teaching herein provided will understand and appreciate that the broader practice and application of the processing herein described is not necessarily so limited and such conjunctive or associated use or practice is not necessarily so required.

In the heat recovery cycle thermal energy conveyance process 50 shown in FIG. 2, solid particles from the hot separation and storage vessel(s) 12 are mixed with a carrier fluid, such as air such as supplied or provided via an air blower or compressor 52, and transported via a line 54 through a cooling zone 56, such as a particle-fluid mixture to a fluid heat exchanger or a process heating equipment, for example. In the cooling zone 56, the fluid-particle mixture transfers a portion of its thermal energy to the fluid being heated or to the process and as a result is cooled to a lower temperature. As shown, such cooling can be by means of air such as supplied or provided via a line 60 from a power block and such as resulting in a stream of hot air such as returned to the power block via a line 62. The resulting cooler particle-fluid mixture is then transported such as via a line 64 to the cold separation and storage vessels(s) 14, where the particles are separated from the carrier fluid and stored for use during the heating cycle, such as shown in FIG. 1.

Moreover, while aspects of the invention have been described making reference to a specific or particular configuration, a wide range of other configurations are possible. Further, the development herein described can, if desired, be used or employed in a continuous heating-cooling configuration such as where both heating and cooling are carried out continuously and simultaneously. Further, the subject development can be used or employed without one of the hot and cold storage vessels or in a closed loop such as using an in line particle-gas mixture pump.

It is to be understood and appreciated that transport and/or storage systems employed in the practice of the processing herein described can be operated under pressure or under vacuum, as may be desired for particular applications.

While not required in the broader practice of the developments herein described, in particular applications the incorporation and use of thermally insulated transport and storage components may be preferred to reduce or minimize heat losses.

It is to be understood and appreciated that the broader practice of the subject development is not necessarily limited to use or practice with specific or particular separators or separation techniques or, correspondingly, specific or particular mixers or mixing techniques, relative to the heat transfer fluids herein described. For example, a wide range of devices or techniques can be used to separate particles from gas (e.g. cyclone separator, cartridge filters, baghouse, etc.) and to feed particles into the carrier fluid (e.g. rotary valve, venturi mixer, etc.). These and other techniques and devices are well known, established and/or commonly practiced such as in the petrochemical and other industries, for example.

It is to be further understood and appreciated that features or components such as the filtering and/or feeding component(s) can suitably be incorporated and, if desired, integrated such as with or in a storage vessel or built into a separate housing and connected to the vessel, such as may be desired for particular applications.

A wide range of gaseous fluids are useable as the carrier fluid. Suitable gaseous carriers can include air, nitrogen, carbon dioxide, inert gases and combinations thereof. In accordance with one embodiment, air is a preferred carrier fluid such as for use in an open loop, for example.

A wide range of naturally occurring and synthetic materials or solids can be used as or to provide solid particles employed in a heat transfer fluid as herein provided and such as depending on their thermal, mechanical and/or flow properties and the specific or particular use or application. Examples of suitable materials can include carbon, sand, minerals, alumina, corundum, silicon carbide, metals, metal oxides, glass, graphite, graphene, talc, refractory material, iron, iron oxide and combinations thereof, with combinations including multi-component, layered, or coated particles engineered to optimize desired properties or to minimize undesired properties, for example.

While the broader practice of the development herein described is not necessarily limited to employment with specific or particularly sized particles as a wide range of particle sizes ranging from submicron to millimeter in diameter can, if desired, be employed, a preferred particle size for use in selected embodiments is in the range of 30 to 250 micron.

The subject development is suitably applicable to dilute-to-dense phase transport of particle-gas mixture. In one embodiment, a preferred approach is to use or employ a dilute-to-dense phase transport, e.g., a dilute-to-dense phase loading of the micron sized solid particles, to maximize heat transfer rates and minimize transport velocity, particle attrition and transport component erosion. In specific or particular embodiments, suitable dilute-to-dense phase loading of the micron sized solid particles can refer to a micron sized solids particle loading level of at least 2.0, micron sized solids particle a loading level of at least 2.5, a micron sized solids particle loading level of greater than 10, a micron sized solids particle loading level of greater than 20, a micron sized solids particle loading level of at least 30 or a micron sized solids particle loading level of at least 100.

If desired, suitable flow loop designs can incorporate single or multiple branches separating and combining as appropriate, and one or more storage vessels can be used for either or both cold and hot storage of particles.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

### Examples 1-5

Tests were carried out to assess the heat transfer impacts of adding solid powder to a gas, the ability to maintain flow, and the ability to separate the particles from gas.

In these tests, expanded graphite in air was used to demonstrate significant increases in heat transfer rates compared with particle-free air.

The test stand was constructed from ½ inch stainless steel tubing running through two high temperature electric tube heaters for heating the material under investigation. Air flow through the test stand was measured using a variable area flow meter installed upstream of the powder feed. The powder was added through a small hopper/funnel attached to a piping tee installed in the main tubing run by opening a small gate valve located above the feed port. The motive force to move both the gas and the test material was a HEPA vacuum attached at the outlet of the tubing, run after a fan cooled coil. The use of the HEPA vacuum allowed for the efficient collection, post-test measurement, and reuse of the test material. The test stand was configured with four thermocouples to measure the temperature of the gas/powder mixture: before the first heater; between the heaters; and after the second heater.

These tests were carried out at an air flow rate of 2.5 scfm and a temperature of approximately 400° F./200° C. using expanded graphite as the particles. The graphite has a density of 16.63 ft³/lbm, specific heat of 0.242 Btu/lbm*° F. and thermal conductivity of 150 W/(k·m) at 400° F./200° C.

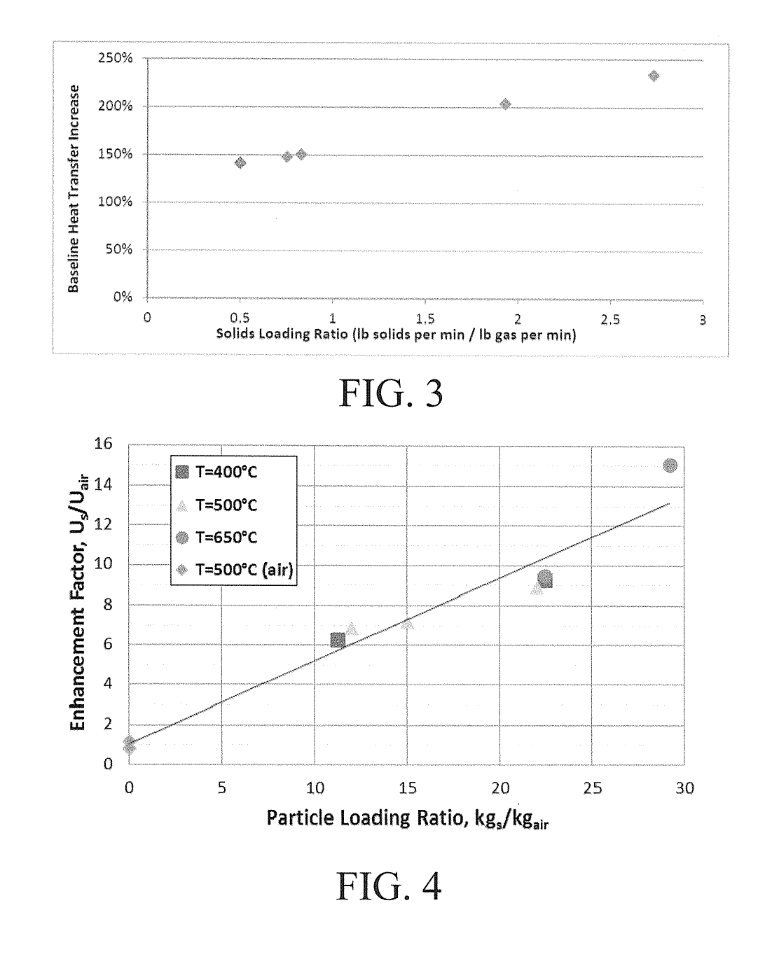

FIG. 3 shows the relationship between heat transfer increases over particle-free air as a function of particle loading.

As shown, heat transfer increased linearly with particle loading reaching 2.5 times at a particle loading of 2.5. This increase is much greater than the increase for larger glass particles tested by Farber and Depew, referred to above, suggesting very high heat transfer rates could potentially be achieved using properly sized expanded graphite such as at proposed 10-20 to 1 loading ratios. No issues with maintaining flows were observed and the HEPA filter equipped vacuum was able to effectively capture the particles, with no visible dust observed either during or after the tests on or around the vacuum.

### Examples—with 70 μm Alumina

Further testing was conducted employing 70 μm alumina particles in air at particle to air loading ratios up to 50:1 and temperatures up to 1202° F./650° C.

These tests employed a particle-air mixture flow loop that had several cross sectional non-uniformities and obstructions, such as bends, fittings, pressure gauges, inserted thermocouples, and inline circulation pump. The particle-gas media was heated up to 1202° F./650° C. using electric heaters and then cooled in a water-cooled heat exchanger.

FIG. 4 is a graphical presentation of heat transfer increase enhancement factor versus particle loading results obtained and showing heat transfer enhancement with particle loading ratio.

The results further showed or demonstrated no clogging, no particle degradation, and no heat transfer and pressure drop changes for over 4,000 heating cooling cycles (212° F./100° C. to 1202° F./650° C.). The flow was stopped and started many times during the tests without cleaning the loop.

The heat transfer coefficient for particle-gas media at a particle to air weight ratio of 30 reached 15 times the value measured with air alone, as shown in FIG. 4. Also, the heat transfer coefficient enhancement levels at different particle to air weight ratios were similar for 752° F./400° C., 932° F./500° C., and 1202° F./650° C.

Those skilled in the art and guided by the teachings herein provided will understand and appreciate that the subject approach of using a particle laden gas as a combined heat transfer and storage media provides or offers a number of advantages or benefits over current technologies employed in high temperature thermal transfer and storage applications, for example, including one or more of the following:

a. Allows direct absorption of solar energy by or into solid particles such as when using a receiver made from materials that are substantially transparent to solar radiation (e.g. borosilicate glass).

b. Provides direct contact heat transfer between particles and the carrier fluid such as to eliminate heat exchanger surface and dramatically increase heat transfer rates during both energy storage and energy recovery.

c. Allows use of a single closed loop combining both energy transfer and storage. d. A wide range of useful and useable materials area available offering, providing or resulting in a desirable possible performance costs tradeoffs.

e. No direct link between temperature and pressure of the fluid resulting from increased vapor pressures at higher temperatures.

f. Potential to achieve temperatures of greater than 2100° F., limited only by the ability of transport and storage equipment to handle the hot media.

g. Potential for direct contact storage and recovery of heat for higher efficiencies and fewer exchange surfaces.

h. Improved or increased costs control such as through choice of materials.

i. Advantages over the use of molten salts can include one or more of: less sensitivity of viscosity to temperature, no need to maintain temperatures above melting point to avoid solidification/freezing, no side reactions, noncorrosive, elimination of the minimal vapor pressure of molten salts, elimination of salt reactions, and potential for much higher temperatures.

j. Advantages over the use of thermal oils can include one or more of: more efficient storage, no need to maintain temperatures above a certain limit to maintain flow properties, ability to create a non flammable gas particle mixture and ability to operate at low pressures.

The invention illustratively disclosed herein suitably may be practiced in the absence of any element, part, step, component, or ingredient which is not specifically disclosed herein.

The claims are not intended to include, and should not be interpreted to include, means-plus- or step-plus-function limitations, unless such a limitation is explicitly recited in a given claim using the phrase(s) “means for” or “step for,” respectively.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A thermal energy conveyance process, said process comprising at least one of:
a. transferring heat to a first heat transfer fluid; and
b. recovering heat from a second heat transfer fluid;
wherein the first and the second heat transfer fluids comprise a gaseous carrier containing a quantity of micron sized solid particles and wherein the at least one of transferring heat and recovering heat is conducted to involve at least one of a) a temperature in excess of 1000° F. and b) a dilute-to-dense phase of the micron sized solid particles.

2. The process of claim 1 wherein the at least one of transferring heat and recovering heat is conducted to involve a temperature in excess of 1000° F.

3. The process of claim 1 wherein the at least one of transferring heat and recovering heat is conducted to involve a temperature in excess of 1050° F.

4. The process of claim 1 wherein the at least one of transferring heat and recovering heat is conducted to involve a temperature in excess of 1100° F.

5. The process of claim 1 wherein the at least one of transferring heat and recovering heat is conducted to involve a dilute-to-dense phase of the micron sized solid particles.

6. The process of claim 5 wherein the dilute-to-dense phase of the micron sized solid particles comprises a solids loading ratio of at least 2.

7. The process of claim 5 wherein the dilute-to-dense phase of the micron sized solid particles comprises a solids loading ratio of at least 2.5.

8. The process of claim 5 wherein the dilute-to-dense phase of the micron sized solid particles comprises a solids loading ratio of greater than 10.

9. The process of claim 5 wherein the dilute-to-dense phase of the micron sized solid particles comprises a solids loading ratio of greater than 20.

10. The process of claim 5 wherein the dilute-to-dense phase of the micron sized solid particles comprises a solids loading ratio of at least 30.

11. The process of claim 5 wherein the dilute-to-dense phase of the micron sized solid particles comprises a solids loading ratio of at least 100.

12. The process of claim 1 wherein the gaseous carrier is selected from the group consisting of air, nitrogen, carbon dioxide, inert gases and combinations thereof.

13. The process of claim 1 wherein the micron sized particles are in a particle size range of 30 to 250 microns.

14. The process of claim 1 wherein the micron sized particles comprise a material selected from the group consisting of carbon, composite material, alumina, sand, minerals, corundum, silicon carbide, metals, metal oxides, glass, graphite, graphene, talc, refractory material, iron, iron oxide and combinations, either as multi-component or layered particles, thereof.

15. The process of claim 1 wherein:
the first and the second heat transfer fluids comprise a gaseous carrier selected from the group consisting of air, nitrogen, carbon dioxide, inert gases and combinations thereof and containing a quantity of micron sized solid particles in a particle size range of 30 to 250 microns and wherein the at least one of transferring heat and recovering heat is conducted to involve at least one of a) a temperature in excess of 1100° F. and b) a dilute-to-dense phase of the micron sized solid particles having a solids loading ratio of at least 2.

16. A thermal energy conveyance process, said process comprising at least one of:
a. transferring heat to a first heat transfer fluid; and
b. recovering heat from a second heat transfer fluid;
wherein the first and the second heat transfer fluids comprise a gaseous carrier comprising air and containing a quantity of micron sized solid particles comprising carbon or alumina and wherein the at least one of transferring heat and recovering heat is conducted to involve at least one of a) a temperature in excess of 1050° F. and b) a dilute-to-dense phase of the micron sized solid particles having a solids loading ratio of at least 2.

17. A media adapted for at least one heat conveyance operation selected from the group consisting of heat transport, heat transfer and heat storage, the media comprising:
a gaseous carrier fluid containing a quantity of micron sized solid particles and wherein the at least one heat conveyance operation is conducted to involve at least one of a) a temperature in excess of 1000° F. and b) a dilute-to-dense phase of the micron sized solid particles.

18. The media of claim 17 wherein the at least one heat conveyance operation is conducted to involve a temperature in excess of 1050° F.

19. The media of claim 17 wherein the at least one heat conveyance operation is conducted to involve a dilute-to-dense phase of the micron sized solid particles having a solids loading ratio of at least 2.5.
